(19) United States
(12) Patent Application Publication
(10) Pub. No.: US 2017/0228438 A1
(43) Pub. Date: Aug. 10, 2017

(54) Custom Taxonomy

(71) Applicant: International Business Machines Corporation, Armonk, NY (US)

(72) Inventors: Aaron J. Chavez, Denver, CO (US); Elliot B. Turner, Denver, CO (US)

(21) Appl. No.: 15/016,549

(22) Filed: Feb. 5, 2016

(51) Int. Cl. G06F 17/30; G06N 99/00

(52) U.S. Cl. CPC G06F 17/30539; G06N 99/005

(57) ABSTRACT

An approach is provided in which a knowledge manager trains a custom taxonomy classifier based upon a set of training samples that results in the custom taxonomy classifier understanding relationships between a set of pre-leaned terms. The knowledge manager then uses the custom taxonomy classifier to analyze input data and determine that the input data corresponds to one or more of the pre-learned terms. In turn, the custom taxonomy classifier matches the corresponding pre-learned terms to user-defined categories and assigns the input data to the matched user-defined categories.

### BACKGROUND

The present disclosure relates to an approach of building a custom taxonomy classifier that categorizes user documents based upon a taxonomy definition that maps user-defined categories to pre-learned terms of the custom taxonomy classifier.

Today's classification systems typically use classifiers to categorize documents, images, sound sequences, and other various forms of data. A classifier is an algorithm for deciding, for an input case, to which one class among multiple candidate classes the input case belongs. Prior to using classifiers to classify input data, the classifiers are trained against a set of training samples. The training samples are typically labeled based upon a particular taxonomy that describes the way in which input data is to be classified, or categorized. The taxonomy may include relationship schemes (e.g., parent-child relationships), an organization of items into groups, hierarchically organized terms, etc.

Users typically have different approaches to classifying documents for various reasons and, therefore, prefer different taxonomies. However, once a classifier trains on a set of training data and taxonomy, the classifier classifies input data according to the specific taxonomy. As a result, the classifier requires retraining each time a user wishes to change taxonomies.

### BRIEF SUMMARY

According to one embodiment of the present disclosure, an approach is provided in which a knowledge manager trains a custom taxonomy classifier based upon a set of training samples that results in the custom taxonomy classifier understanding relationships between a set of pre-leaned terms. The knowledge manager then uses the custom taxonomy classifier to analyze input data and determine that the input data corresponds to one or more of the pre-learned terms. In turn, the custom taxonomy classifier matches the corresponding pre-learned terms to user-defined categories and assigns the input data to the matched user-defined categories.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented; and

FIG. 2 provides an extension of the information handling system environment shown in FIG. 1 to illustrate that the methods described herein can be performed on a wide variety of information handling systems which operate in a networked environment;

FIG. 3 depicts a knowledge manager that uses a custom taxonomy classifier to categorize documents according to a user's custom taxonomy;

FIG. 4 is an exemplary diagram depicting a taxonomy definition that maps a user's custom taxonomy to pre-learned terms of a custom taxonomy classifier;

FIG. 5 depicts a flowchart showing steps taken to build a custom taxonomy classifier and a taxonomy definition; and

FIG. 6 depicts a flowchart showing steps taken to categorize input data based upon a user's custom taxonomy.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

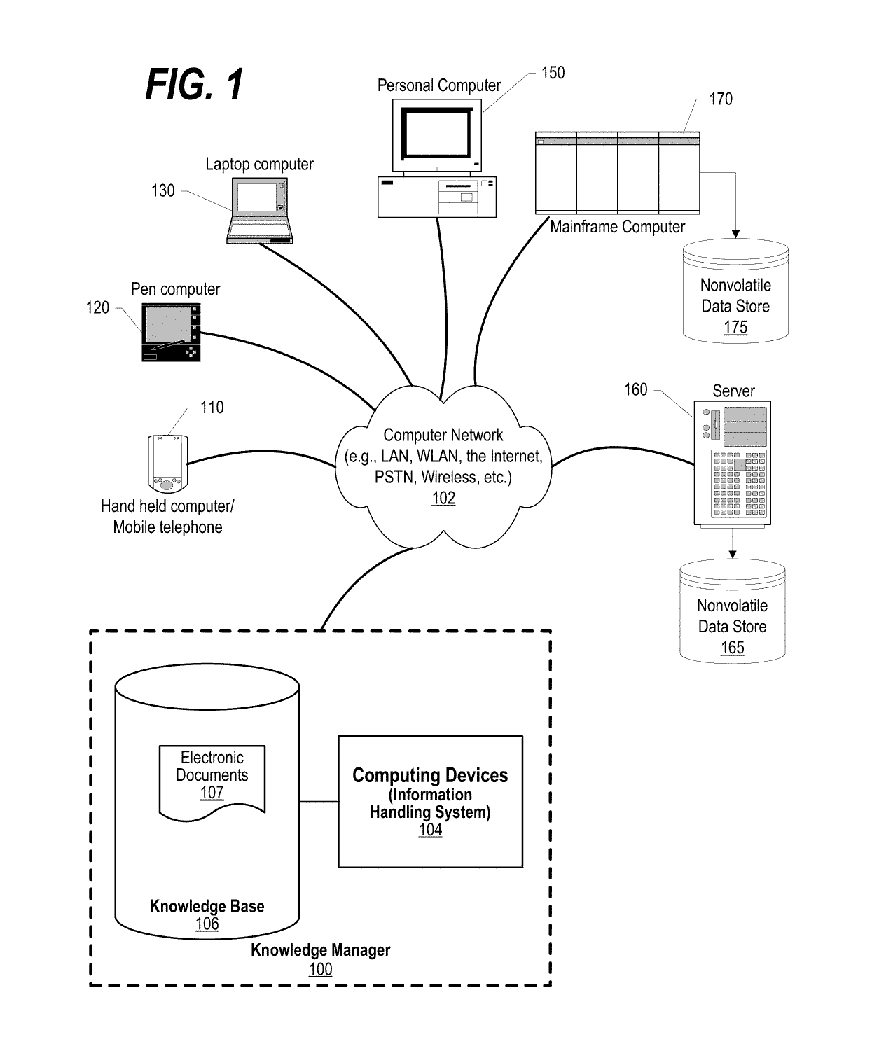

FIG. 1 depicts a schematic diagram of one illustrative embodiment of a question/answer (QA) system knowledge manager 100 in a computer network 102. Knowledge manager 100 may include a computing device 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. Knowledge manager 100 and network 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the network 102, a corpus of electronic documents 107 or other data, a content creator 108, content users, and other possible sources of input. In one embodiment, some or all of the inputs to knowledge manager 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured resource sources. In this manner, some processes populate the knowledge manager with the knowledge manager also including input interfaces to receive knowledge requests and respond accordingly.

In one embodiment, the content creator creates content in a document 107 for use as part of a corpus of data with knowledge manager 100. The document 107 may include any file, text, article, or source of data for use in knowledge manager 100. Content users may access knowledge manager 100 via a network connection or an Internet connection to the network 102, and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

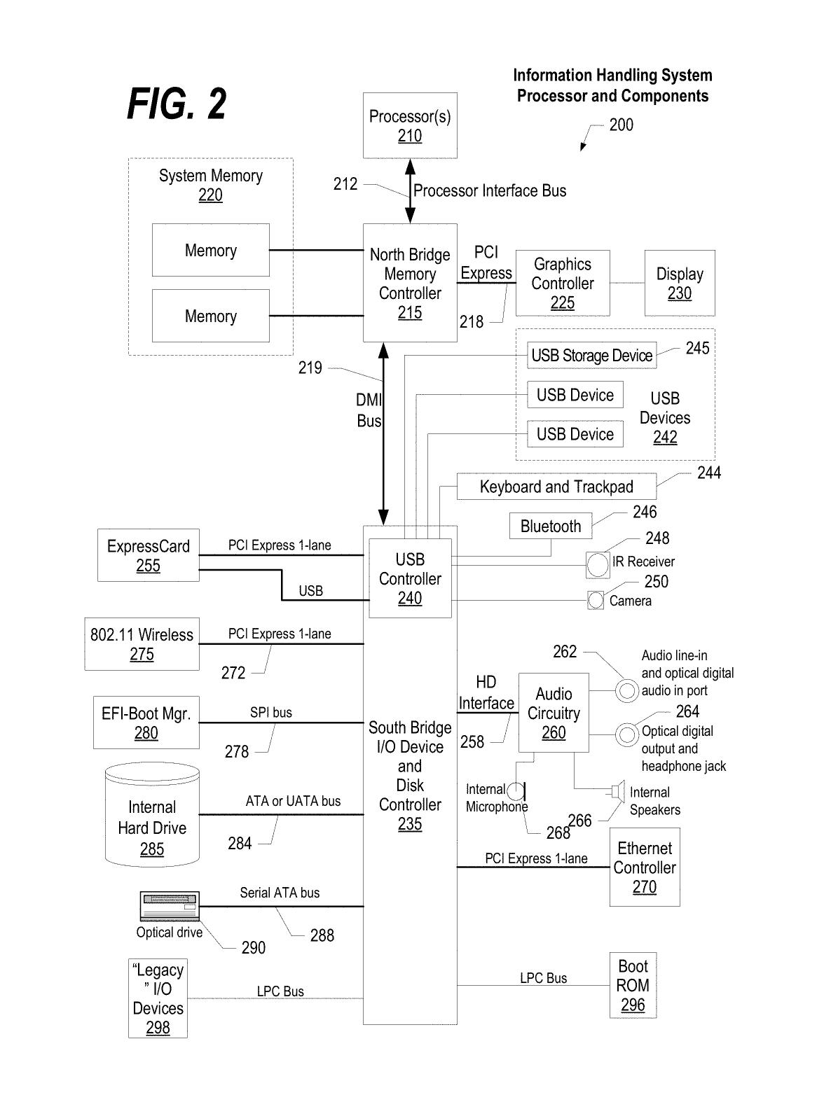

Types of information handling systems that can utilize knowledge manager 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 100. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219.

In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, et cetera.

Wireless Local Area Network (LAN) device 275 connects to Southbridge 235 via the PCI or PCI Express bus 272. LAN device 275 typically implements one of the IEEE 802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

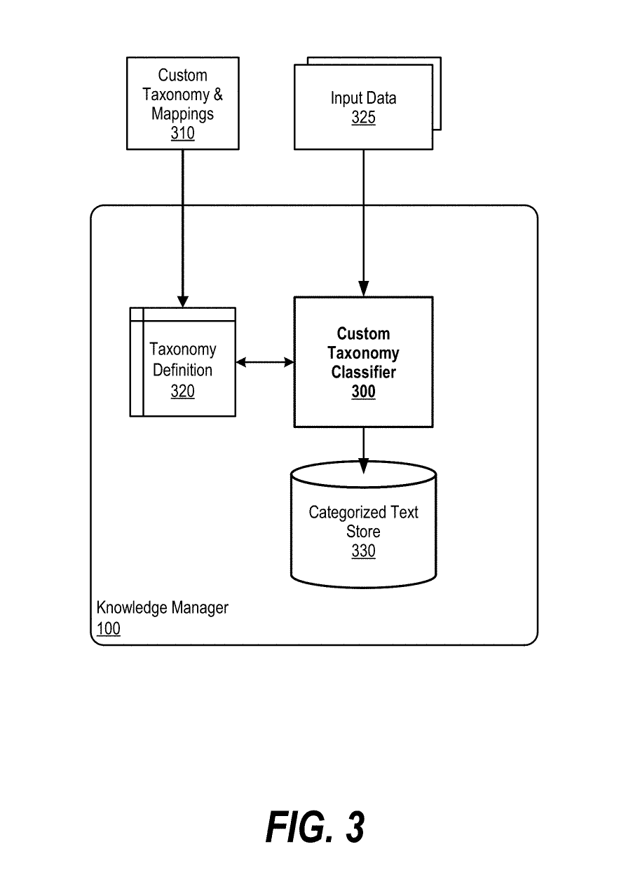

FIGS. 3 through 6 depict an approach that can be executed on an information handling system. The information handling system builds a custom taxonomy classifier and uses the custom taxonomy classifier in conjunction with a user-specific taxonomy definition to categorize documents according to the user-specific taxonomy definition without having to retrain the custom taxonomy classifier.

FIG. 3 depicts a knowledge manager that uses a custom taxonomy classifier to categorize documents according to a user's custom taxonomy. Knowledge manager 100 trains custom taxonomy classifier 300 in a manner such that custom taxonomy 300 understands relationships between hundreds of thousands of terms and understands ways in which terms are indicative of each other based on word embeddings, knowledge graphs, parent/child relationships, large scale word co-occurrence, etc. In short, custom taxonomy classifier 300 learns rules whereby terms are related to each other, such as where “a” indicates “b.”

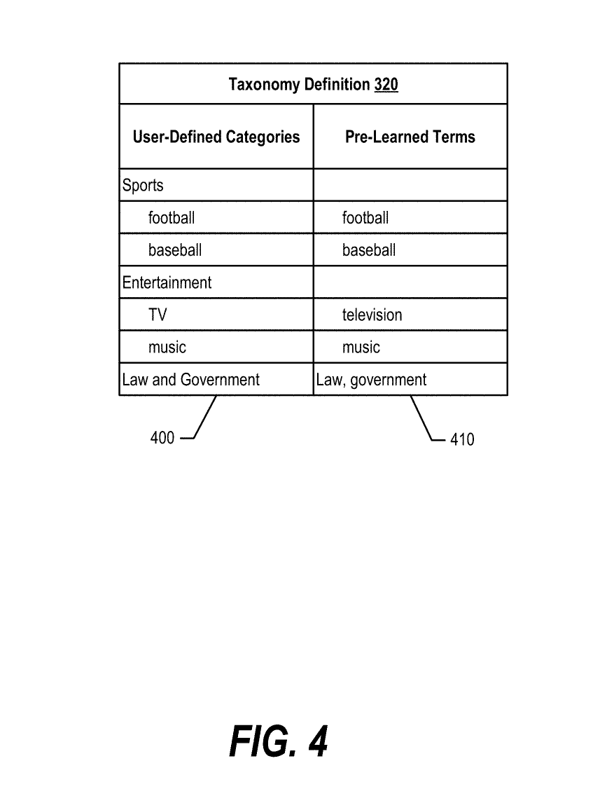

When a user wishes to apply their own custom taxonomy to input data 325, the user provides custom taxonomy and mappings 310 to knowledge manager 100. Custom taxonomy and mappings 310 include the user's custom taxonomy, such as custom terms, categories, sub-categories, on how the user wishes to have input data 325 categorized, as well as mappings that maps the user's custom taxonomy to pre-learned terms known by custom taxonomy classifier 300. For example, the user may wish to have a category “law and government” that maps to pre-learned terms “law” and “government” (see FIG. 4 and corresponding text for further details).

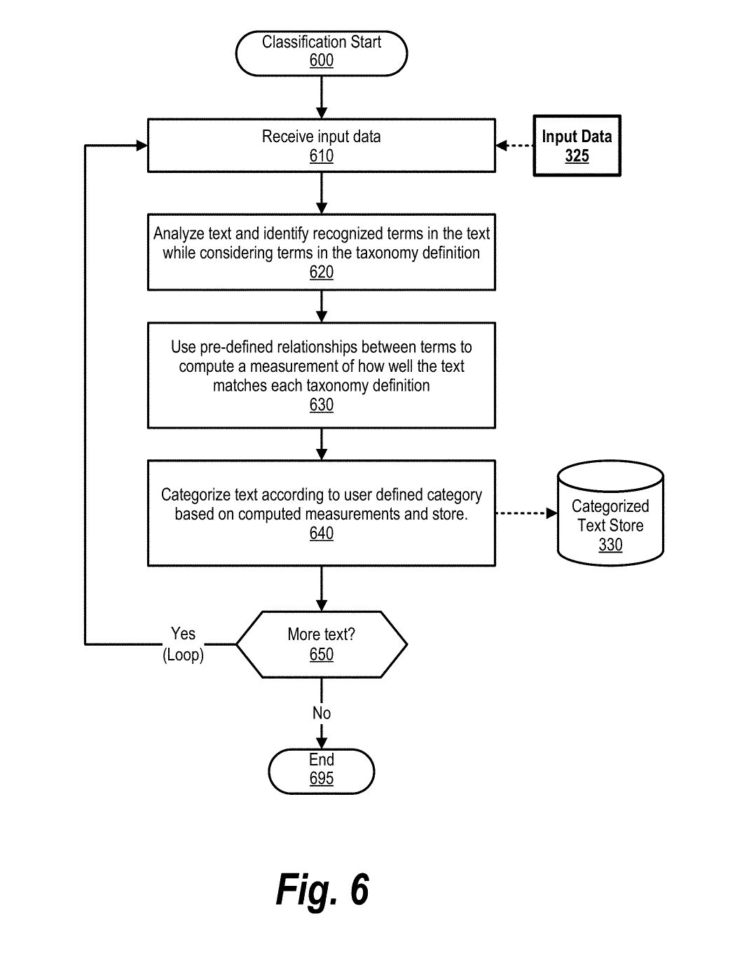

In turn, custom taxonomy classifier 300 uses taxonomy definition 320 to classify input data 325 based on the user's custom taxonomy and store the categorized documents in categorized text store 330. In one embodiment, custom taxonomy classifier 300 uses already-defined relationships between pre-learned terms to compute a measurement of how well the text in input data 325 matches each taxonomy definition. In this embodiment, custom taxonomy classifier 300 may use primary metrics to determine whether terms may be related such as a) how often terms co-occur in a large web corpus, b) how similar terms are based on a pre-existing neural network trained to learn word similarity, c) whether the terms are related in a pre-existing knowledge graph that stores millions of “parent⇄child” relationships, etc. (see FIG. 6 and corresponding text for further details).

FIG. 4 is an exemplary diagram depicting a taxonomy definition that maps a user's custom taxonomy to pre-learned terms of a custom taxonomy classifier. Taxonomy definition 320, in one embodiment, includes user-defined categories column 400 and pre-learned terms 410. Column 400 is a user's custom taxonomy that is organized based on the user's preferences. The example in FIG. 4 shows that the user has a category “Sports” with subcategories “football” and “baseball.” Column 410 shows that the user mapped the subcategories to pre-learned terms “football” and “baseball,” respectively. As such, when custom taxonomy classifier 300 determines a section of text corresponds to a pre-learned term of “football,” custom taxonomy classifier 300 categories the section of text under “sports/football.”

In one embodiment, a user may map multiple pre-learned terms to a user-defined category. FIG. 4 shows that pre-learned terms “law” and “government” are both mapped to the user's category “law and government.” As such, text that corresponds to “law” or “government” is categorized under the user's category of “law and government.”

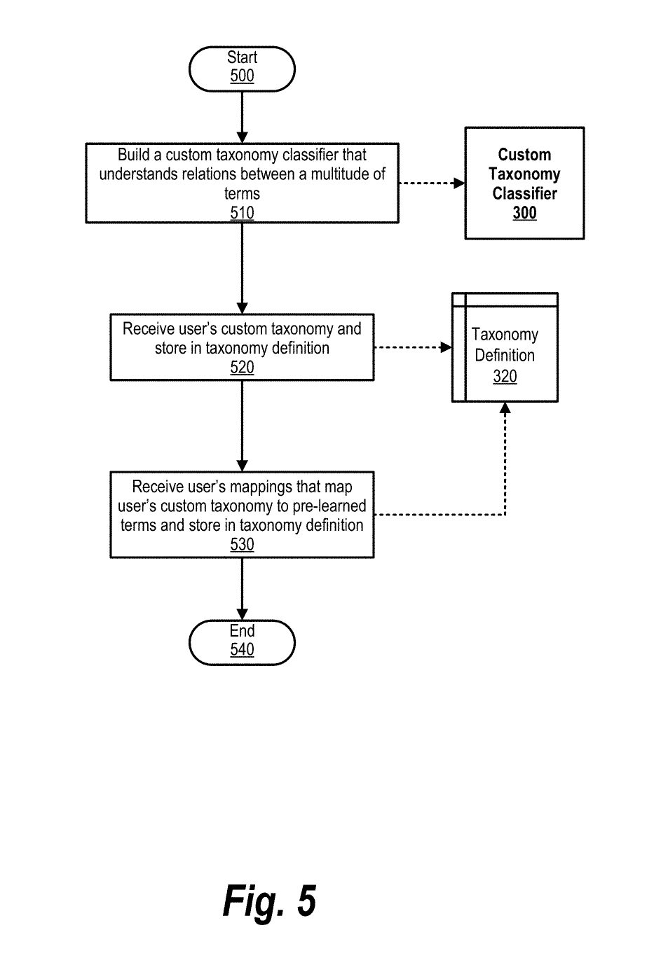

FIG. 5 depicts a flowchart showing steps taken to build a custom taxonomy classifier and a taxonomy definition. Processing commences at 500, whereupon the process builds custom taxonomy classifier 300. Custom taxonomy classifier 300 is built to describe a way in which terms are indicative of each other using word embeddings, knowledge graphs, parent/child relationships, large scale word co-occurrence, etc., to arrive at an indicative measurement of terms, such as terse definitions of where “a” indicates “b.” As such, custom taxonomy classifier 300 is able to take two arbitrary terms and relate them to each other because it learned the definition between terms by learning the rules whereby they are related.

At step 520, the process receives a user's custom taxonomy (user-defined categories) and stores the custom taxonomy in taxonomy definition 320 (see column 400 in FIG. 4 and corresponding text for further details). Next, at step 530, the process receives the user's mappings that maps the user's custom categories to pre-learned terms. For example, the user may map the user-defined category of “sports/football” to a pre-learned term of “football.” As those skilled in the art can appreciate, steps 520 and 530 may be combined into a single step whereby the user provides a complete taxonomy definition file that includes the custom taxonomy and mappings. Processing ends at 540.

FIG. 6 depicts a flowchart showing steps taken to categorize input data based upon a user's custom taxonomy. Processing commences at 600, whereupon the process receives input data 325 at step 610. At step 620, the process analyzes the input data and associates the input data to pre-learned terms of custom taxonomy classifier 300. In one embodiment, the process also considers user-defined category terms in the taxonomy definition.

At step 630, the process uses pre-defined relationships between the pre-learned terms to compute measurements of how well the text matches to each taxonomy definition. In one embodiment, the primary metrics to determine if terms are related are how often terms co-occur in a large web corpus, how similar terms are based on a pre-existing neural network trained to learn word similarity, and whether the terms are related in a pre-existing knowledge graph that stores millions of “parent⇄child” relationships.

Next, at step 640, the process categorizes the text according to the user-defined categories. For example, if the process determines that an article is about football, the process categories the article as “sports/football” because of the taxonomy definition that maps “football” to “sports/football.” The process stores the categorized text in categorized text store 330.

A determination is made as to whether there is more text to categorize (decision 650). If there is more text to analyze, decision 650 branches to the “Yes” branch, whereupon the process receives and processes additional text. This looping continues until there is no more text to analyze, at which point decision 650 branches to the “No” branch, whereupon processing ends at 695.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
training a custom taxonomy classifier using a set of training samples, resulting in the custom taxonomy classifier realizing a plurality of pre-learned terms;
building a first taxonomy definition that maps a set of the plurality of pre-learned terms to a plurality of user-defined categories;
correlating, by the trained custom taxonomy classifier, a set of input data to a selected one of the plurality of pre-learned terms; and
subsequent to correlating the set of input data to the selected one of the plurality of pre-learned terms and without retraining the trained custom taxonomy classifier, the trained custom taxonomy classifier performs steps of:
mapping the selected pre-learned term to a selected one of the plurality of user-defined categories based on the first taxonomy definition; and
assigning the selected user-defined category to the correlated set of input data.

2. (canceled)

3. The method of claim 1 further comprising:
building a second taxonomy definition that maps the set of pre-learned terms to a different plurality of user-defined categories;
without retraining the trained custom taxonomy classifier, using the second taxonomy definition to map the selected pre-learned term to a different user-defined category included in the different plurality of user-defined categories; and
assigning the different user-defined category to the correlated set of input data.

4. The method of claim 1 further comprising:
mapping both a first one of the plurality of pre-learned terms and a second one of the plurality of pre-learned terms to a single one of the plurality of user-defined categories.

5. The method of claim 1 further comprising:
determining, during the training of the custom taxonomy classifier, one or more relationships between the plurality of pre-learned terms; and
using the one or more relationships during the correlating of the set of input data to the selected pre-learned term.

6. The method of claim 5 wherein the at least one of the one or more relationships corresponds to an understanding of which of the plurality of pre-learned terms are indicative of each other.

7. The method of claim 5 wherein at least one of the one or more relationships is determined based upon an approach selected from the group consisting of word embeddings, knowledge graphs, parent/child relationships, and large scale word co-occurrences.

8. An information handling system comprising:
one or more processors;
a memory coupled to at least one of the processors; and
a set of computer program instructions stored in the memory and executed by at least one of the processors in order to perform actions of:
training a custom taxonomy classifier using a set of training samples, resulting in the custom taxonomy classifier realizing a plurality of pre-learned terms;
building a first taxonomy definition that maps a set of the plurality of pre-learned terms to a plurality of user-defined categories;
correlating, by the trained custom taxonomy classifier, a set of input data to a selected one of the plurality of pre-learned terms; and
subsequent to correlating the set of input data to the selected one of the plurality of pre-learned terms and without retraining the trained custom taxonomy classifier, the trained custom taxonomy classifier performs actions of:
mapping the selected pre-learned term to a selected one of the plurality of user-defined categories based on the first taxonomy definition; and
assigning the selected user-defined category to the correlated set of input data.

9. (canceled)

10. The information handling system of claim 8 wherein at least one of the one or more processors perform additional actions comprising:
building a second taxonomy definition that maps the set of pre-learned terms to a different plurality of user-defined categories;
without retraining the trained custom taxonomy classifier, using the second taxonomy definition to map the selected pre-learned term to a different user-defined category included in the different plurality of user-defined categories; and
assigning the different user-defined category to the correlated set of input data.

11. The information handling system of claim 8 wherein at least one of the one or more processors perform additional actions comprising:
mapping both a first one of the plurality of pre-learned terms and a second one of the plurality of pre-learned terms to a single one of the plurality of user-defined categories.

12. The information handling system of claim 8 wherein at least one of the one or more processors perform additional actions comprising:
determining, during the training of the custom taxonomy classifier, one or more relationships between the plurality of pre-learned terms; and
using the one or more relationships during the correlating of the set of input data to the selected pre-learned term.

13. The information handling system of claim 12 wherein the at least one of the one or more relationships corresponds to an understanding of which of the plurality of pre-learned terms are indicative of each other.

14. The information handling system of claim 12 wherein at least one of the one or more relationships is determined based upon an approach selected from the group consisting of word embeddings, knowledge graphs, parent/child relationships, and large scale word co-occurrences. PATENT

15. A computer program product stored in a computer readable storage medium, comprising computer program code that, when executed by an information handling system, causes the information handling system to perform actions comprising:
training a custom taxonomy classifier using a set of training samples, resulting in the custom taxonomy classifier realizing a plurality of pre-learned terms;
building a first taxonomy definition that maps a set of the plurality of pre-learned terms to a plurality of user-defined categories;
correlating, by the trained custom taxonomy classifier, a set of input data to a selected one of the plurality of pre-learned terms; and
subsequent to correlating the set of input data to the selected one of the plurality of pre-learned terms and without retraining the trained custom taxonomy classifier, the trained custom taxonomy classifier performs actions of:
mapping the selected pre-learned term to a selected one of the plurality of user-defined categories based on the first taxonomy definition; and
assigning the selected user-defined category to the correlated set of input data.

16. (canceled)

17. The computer program product of claim 15 wherein the information handling system performs additional actions comprising:
building a second taxonomy definition that maps the set of pre-learned terms to a different plurality of user-defined categories;
without retraining the trained custom taxonomy classifier, using the second taxonomy definition to map the selected pre-learned term to a different user-defined category included in the different plurality of user-defined categories; and
assigning the different user-defined category to the correlated set of input data.

18. The computer program product of claim 15 wherein the information handling system performs additional actions comprising:
mapping both a first one of the plurality of pre-learned terms and a second one of the plurality of pre-learned terms to a single one of the plurality of user-defined categories.

19. The computer program product of claim 15 wherein the information handling system performs additional actions comprising:
determining, during the training of the custom taxonomy classifier, one or more relationships between the plurality of pre-learned terms; and
using the one or more relationships during the correlating of the set of input data to the selected pre-learned term.

20. The computer program product of claim 19 wherein the at least one of the one or more relationships corresponds to an understanding of which of the plurality of pre-learned terms are indicative of each other.
